(19) United States
(12) Patent Application Publication
(10) Pub. No.: US 2025/0371375 A1
(43) Pub. Date: Dec. 4, 2025

(54) TRANSFORMATION APPARATUS

(71) Applicant: NEC Corporation, Minato-ku, Tokyo (JP)

(72) Inventor: Motoi SUZUKI, Tokyo (JP)

(73) Assignee: NEC Corporation, Minato-ku, Tokyo (JP)

(21) Appl. No.: 18/875,222

(22) PCT Filed: Jul. 21, 2022
(86) PCT No.: PCT/JP2022/028325

§ 371 Date: Dec. 16, 2024

(51) Int. Cl. G06N 5/01

(52) U.S. Cl. CPC G06N 5/01

(57) ABSTRACT

A transformation apparatus includes: a selecting unit that selects an auxiliary variable constraint from a list of auxiliary variable constraints represented in a form in which a product of variables matches another variable; and a substituting unit that performs a substitution process based on the auxiliary variable constraint selected by the selecting unit and thereby transforms an evaluation function to be transformed represented by a polynomial with a plurality of variables into a higher-order evaluation function than the evaluation function.

### TECHNICAL FIELD

The present invention relates to a transforming apparatus, a transforming method, and a recording medium.

### BACKGROUND ART

An information processing apparatus and the like that performs a process of solving an optimization problem of optimizing a function such as an evaluation function is known.

A document that describes an example of an optimization apparatus that solves a combinatorial optimization problem is, for example, Patent Literature 1. For example, Patent Literature 1 describes an optimization apparatus that solves an optimization problem of finding a set of variables giving the minimum value of an evaluation function H given in quadratic form and that, especially when some constraint conditions are given to the set of variables, uses the constraints to narrow a search space. According to Patent Literature 1, it is possible to make solution seeking more efficient with the above configuration. Note that the evaluation function H can be written as Formula 1 using a symmetric and square real sequence Q and a binary variable x that takes a value of either 0 or 1.

$$H = {\sum }_{i \leq j} {Q}_{ij} {x}_{i} {x}_{j} \qquad [ Formula 1 ]$$

Further, a related technique is described in, for example, Non-Patent Literature 1. Non-Patent Literature 1 describes a method for reducing a combinatorial optimization problem to a quadratic form. Moreover, Patent Literature 2 describes a method for reducing an evaluation function including a tertiary or higher-order term to a quadratic form by adding auxiliary variables.

### CITATION LIST

### Patent Literature

[Patent Literature 1] International Publication No. WO2021/059338
[Patent Literature 2] JP2021-005363A

### Non-Patent Literature

[Non-Patent Literature 1] A. Lucas, “Ising formulations of many NP problems”, Frontiers in Physics, 2014, Volume 2, Article 5

### SUMMARY OF INVENTION

### Technical Problem

In some combinatorial optimization problems, it is required to handle a higher-order form, but when an evaluation function is given in quadratic form as described in Patent Literature 1, it is difficult to handle an input of higher-order form as it is. Thus, there is a problem that it may be difficult to handle a higher-order term in an optimization apparatus.

Accordingly, an object of the present invention is to provide a transformation apparatus, a transformation method and a program that solve the abovementioned problem.

### Solution to Problem

In order to achieve the object, a transformation apparatus as an aspect of the present disclosure includes: a selecting unit that selects an auxiliary variable constraint from a list of auxiliary variable constraints represented in a form in which a product of variables matches another variable; and a substituting unit that performs a substitution process based on the auxiliary variable constraint selected by the selecting unit and thereby transforms an evaluation function to be transformed represented by a polynomial with a plurality of variables into a higher-order evaluation function than the evaluation function.

Further, a transformation method as another aspect of the present disclosure is a transformation method by an information processing apparatus, and the method includes: selecting an auxiliary variable constraint from a list of auxiliary variable constraints represented in a form in which a product of variables matches another variable; and performing a substitution process based on the selected auxiliary variable constraint and thereby transforming an evaluation function to be transformed represented by a polynomial with a plurality of variables into a higher-order evaluation function than the evaluation function.

Further, a recording medium as another aspect of the present disclosure is a non-transitory computer-readable recording medium with a program recorded thereon, and the program including instructions for causing an information processing apparatus to execute processes to: select an auxiliary variable constraint from a list of auxiliary variable constraints represented in a form in which a product of variables matches another variable; and perform a substitution process based on the selected auxiliary variable constraint and thereby transform an evaluation function to be transformed represented by a polynomial with a plurality of variables into a higher-order evaluation function than the evaluation function.

### Advantageous Effects of Invention

With the configurations as described above, it is possible to solve the abovementioned problem.

### BRIEF DESCRIPTION OF DRAWINGS

FIG. 1 is a block diagram showing an example configuration of a transformation apparatus in a first example embodiment of the present disclosure.

FIG. 2 is a diagram showing an example of auxiliary variable constraint information.

FIG. 3 is a diagram showing an example of penalty term coefficient information.

FIG. 4 is a diagram showing an example of evaluation function information.

FIG. 5 is a flowchart showing an example of operation of a transformation apparatus.

FIG. 6 is a diagram showing another configuration example of the transformation apparatus.

FIG. 7 is a diagram for describing an example of processing by a directed graph creating unit.

FIG. 8 is a diagram showing an example of the hardware configuration of a transformation apparatus in a second example embodiment of the present disclosure.

FIG. 9 is a block diagram showing an example configuration of a transforming apparatus.

### DESCRIPTION OF EXAMPLE EMBODIMENTS

### First Example Embodiment

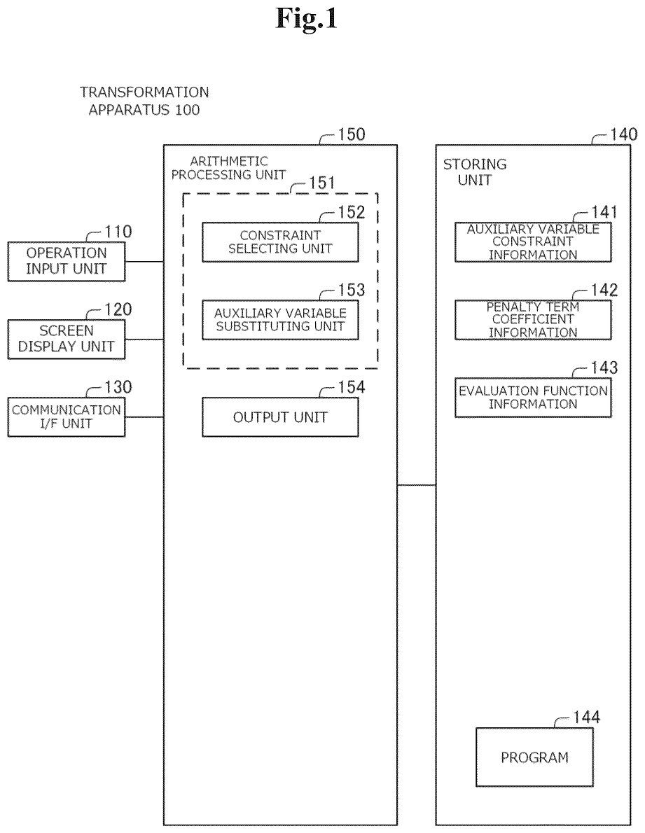

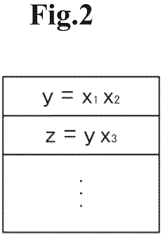

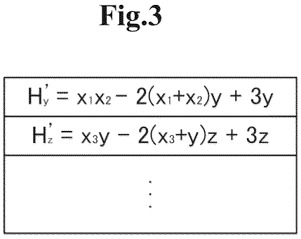

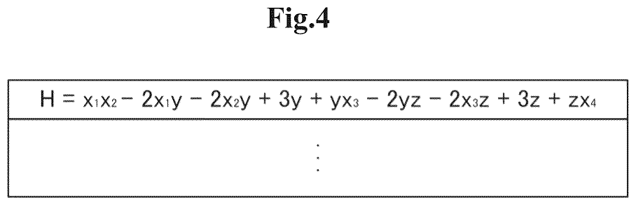

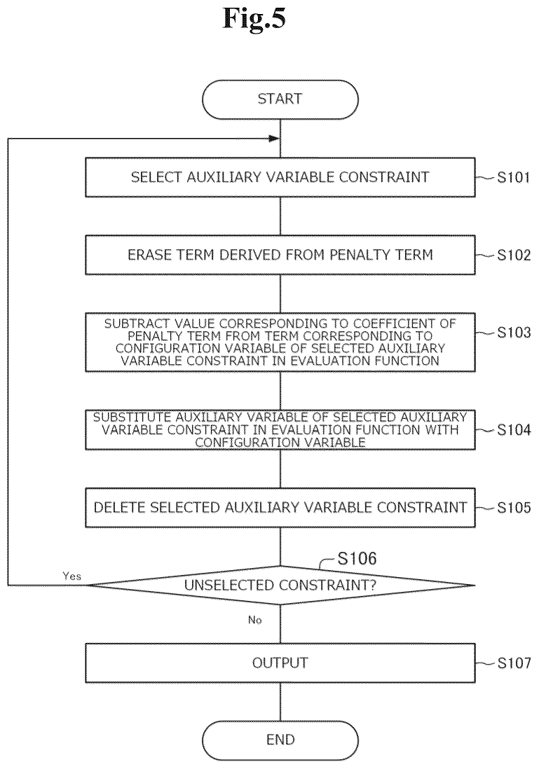

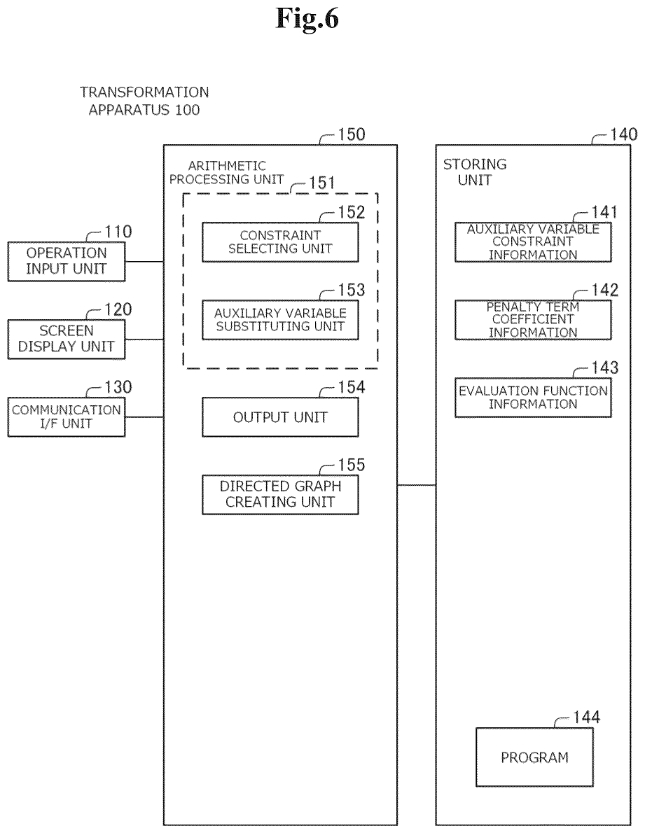

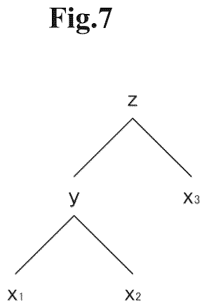

A first example embodiment of the present disclosure will be described with reference to FIGS. 1 to 7. FIG. 1 is a block diagram showing an example configuration of a transformation apparatus 100. FIG. 2 is a diagram showing an example of auxiliary variable constraint information 141. FIG. 3 is a diagram showing an example of penalty term coefficient information 142. FIG. 4 is a diagram showing an example of evaluation function information 143. FIG. 5 is a flowchart showing an example of operation of the transformation apparatus 100. FIG. 6 is a diagram showing another example configuration of the transformation apparatus 100. FIG. 7 is a diagram for describing an example of processing by a directed graph creating unit 155.

In the first example embodiment of the present disclosure, the transformation apparatus 100 that transforms an evaluation function into a higher-order evaluation function and outputs it based on a transformation target evaluation function represented by a polynomial with a plurality of variables and based on a list of auxiliary variable constraints in which the product of one group of variables matches another variable. As will be described later, the transformation apparatus 100 selects an auxiliary variable constraint from the list of auxiliary variable constraints stored as the auxiliary variable constraint information 141. Then, the transformation apparatus 100 performs a transformation process such as substitution and subtraction based on the selected auxiliary variable constraint and a corresponding penalty term coefficient on the transformation target evaluation function. For example, the transformation apparatus 100 transforms a transformation target evaluation function into a higher-order evaluation function by repeating the transformation process described above for each of the auxiliary variable constraints stored as the auxiliary variable constraint information 141.

For example, in Quadratic Unconstrained Binary Optimization (QUBO), which is a quadratic, unconstrained, binary combinatorial optimization problem, an evaluation function H as shown by Formula 2 is given.

$$H = {\sum }_{i \leq j} {Q}_{ij} {x}_{i} {x}_{j} \qquad [ Formula 2 ]$$

Herein, x is a vector of N elements where each element is a binary variable taking 0 or 1, and the elements of x are referred to as spins (or simply variables). Moreover, Q is a real symmetric matrix and is also referred to as a QUBO matrix. In QUBO, a set of x that minimizes H for a given Q is sought. Many combinatorial optimization problems such as the Max-cut problem and the traveling salesman problem can be expressed in the form of QUBO.

The order of an evaluation function may be lowered by introducing an auxiliary variable constraint y=x₂x₃ or the like for the purpose of reducing a high-order evaluation function to a quadratic form so that the QUBO solver described above can be used. At this time, simply introducing an auxiliary variable constraint results in a constraint condition. Therefore, when introducing the auxiliary variable constraint described above, a penalty term that improves the solution only when y=x₂x₃ may be further introduced. In other words, a penalty term such that the value is the smallest when y=x₂x₃ is satisfied and the value is larger than the smallest when y=x₂x₃ is not satisfied is introduced. Consequently, a high-order evaluation function can be rewritten into an unconstrained, low-order evaluation function.

On the other hand, depending on the nature or the like of an optimization problem, it may be convenient to handle a tertiary or higher-order term. Therefore, the transformation apparatus 100 described in the present disclosure performs a transformation process on an evaluation function based on the auxiliary variable constraint, the value of the penalty term coefficient and so forth as described above. Consequently, the transformation apparatus 100 can raise the order in accordance with the need for processing and so forth.

FIG. 1 shows a main example configuration of the transformation apparatus 100. Referring to FIG. 1, the transformation apparatus 100 includes, for example, an operation input unit 110, a screen display unit 120, a communication I/F unit 130, a storing unit 140, and an arithmetic processing unit 150 as main components.

FIG. 1 illustrates a case of realizing a function as the transformation apparatus 100 using one information processing apparatus. However, the transformation apparatus 100 may be realized using a plurality of information processing apparatuses, such as being realized on a cloud, for example. In addition, the transformation apparatus 100 may not include part of the above-described configuration, such as not having the operation input unit 110 or the screen display unit 120, and may have a configuration other than the above-described configuration.

The operation input unit 110 is configured with an operation input device such as a keyboard and a mouse. The operation input unit 110 detects an operation by an operator who operates the transformation apparatus 100 and outputs it to the arithmetic processing unit 150.

The screen display unit 120 is configured with a screen display apparatus such as an LCD (liquid crystal display). The screen display unit 120 can display on a screen a variety of information and so forth stored in the storing unit 140 in response to an instruction from the arithmetic processing unit 150.

The communication I/F unit 130 is configured with a data communication circuit and so forth. The communication I/F unit 130 performs data communication with an external device connected via a communication line.

The storing unit 140 is a storage device such as a hard disk and memory. The storing unit 140 stores processing information and a program 144 that are necessary for a variety of processing by the arithmetic processing unit 150. The program 144 is loaded and executed by the arithmetic processing unit 150, thereby realizing various processing units. The program 144 is loaded in advance from an external device or a recording medium via a data input/output function such as the communication I/F unit 130, and stored in the storing unit 140. Main information stored in the storing unit 140 include, for example, auxiliary variable constraint information 141, penalty term coefficient information 142, evaluation function information 143, and so forth.

The auxiliary variable constraint information 141 shows one or a plurality of auxiliary variable constraints. That is to say, the auxiliary variable constraint information 141 includes a list of auxiliary variable constraints expressed in a form that the product of a group of variables matches another variable. For example, an auxiliary variable constraint of a set of three variables, such as z=xy, is stored in the auxiliary variable constraint information 141. Here, in the auxiliary variable constraint z=xy, z is also referred to as an auxiliary variable, and x and y are also referred to as configuration variables. For example, the auxiliary variable constraint information 141 is acquired in advance by a method such as operating the operation input unit 110 to input or acquiring from an external device via the communication I/F unit 130, and is stored in the storing unit 140. In addition, as an example, the variables are binary variables each taking a value of 0 or 1. However, the variables may be variables other than binary variables.

FIG. 2 shows an example of the auxiliary variable constraint information 141. Referring to FIG. 2, a plurality of auxiliary variable constraints such as y=x₁x₂ and z=yx₃ are stored in the auxiliary variable constraint information 141 as an example. In addition, in the auxiliary variable constraint information 141, an auxiliary variable constraint other than those illustrated in FIG. 2 may be stored. For example, in the auxiliary variable constraint information 141, a constraint of a set of four variables, such as y=x₁x₂x₃, may be stored, or a constraint other than those illustrated above may be stored.

The penalty term coefficient information 142 shows information on a penalty term corresponding to each auxiliary variable constraint stored in the auxiliary variable constraint information 141. For example, the penalty term is expressed as H′=axy+b(x+y)z+cz (note that (x, y, z) belongs to the list of auxiliary variable constraints). Moreover, each coefficient of the penalty term is determined to improve the solution, such as minimize the solution when satisfying the corresponding auxiliary variable constraint. The penalty term coefficient information 142 includes information on coefficients such as a, b and c of the above penalty term. More specifically, the penalty term coefficient information 142 includes information on at least the coefficient a of the penalty term. For example, the penalty term coefficient information 142 is acquired in advance by a method such as operating the operation input unit 110 to input or acquiring from an external device via the communication I/F unit 130, and is stored in the storing unit 140.

FIG. 3 shows an example of the penalty term coefficient information 142. Referring to FIG. 3, in the penalty term coefficient information 142, information on a coefficient of the penalty term corresponding to each auxiliary variable constraint stored in the auxiliary variable constraint information 141, such as H_{y}′=x₁x₂−2(x₁+x₂)y+3y and Hz′=x₃y−2(×3+y)z+3z, is stored as an example. In addition, in the penalty term coefficient information 142, information on a coefficient of the penalty term other than those illustrated in FIG. 3 may be stored. For example, as described above, only information corresponding to the coefficient a of the penalty term may be stored in the penalty term coefficient information 142.

In addition, a coefficient of a penalty term may be fixed as a=1, b=−2, and c=3 regardless of a corresponding auxiliary variable constraint. In a case where a coefficient of a penalty term is fixed, it is sufficient if information on the fixed coefficient is stored in the penalty term coefficient information 142.

The evaluation function information 143 includes information on a transformation target evaluation function represented by a polynomial with a plurality of variables, such as Formula 2 described above. The evaluation function information 143 may include an evaluation function after the transformation process. For example, the evaluation function information 143 is acquired in advance by a method such as operating the operation input unit 110 to input or acquiring from an external device via the communication I/F unit 130, and is stored in the storing unit 140. In addition, for example, the evaluation function information 143 may be updated in accordance with the result of the transformation process by the transforming unit 151 and so forth, which will be described later.

FIG. 4 shows an example of the evaluation function information 143. Referring to FIG. 4, in the evaluation function information 143, an evaluation function of quadratic form, such as H=x₁x₂−2x₁y−2x₂y+3y+yx₃−2yz−2x₃z+3z+zx₄, is stored as an example. In addition, in the evaluation function information 143, an evaluation function other than that illustrated in FIG. 4 may be stored. For example, in the evaluation function information 143, an evaluation function of or tertiary form or more may be stored. In addition, the evaluation function information 143 may include an evaluation function after the transformation.

The arithmetic processing unit 150 has an arithmetic logic unit such as a CPU (Central Processing Unit) and peripheral circuits thereof. The arithmetic processing unit 150 loads the program 144 from the storing unit 140 and executes the program 144, thereby making the above hardware and the program 144 to cooperate and realizing various processing units. Main processing units realized by the arithmetic processing unit 150 include, for example, a transforming unit 151 having a constraint selecting unit 152 and an auxiliary variable substituting unit 153, an output unit 154, and so forth.

In addition, the transformation apparatus 100 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The transforming unit 151 transforms a transformation target evaluation function into a higher-order evaluation function so that, in a case where all the auxiliary variable constraints are satisfied, the values of the original evaluation function and the higher-order evaluation function match and, in a case where all the auxiliary variable constraints are not satisfied, the value of the original evaluation function is not smaller than the value of the higher-order evaluation function. Moreover, the transforming unit 151 performs the above-described transformation process by adding an auxiliary variable and an auxiliary variable constraint to the evaluation function with higher-order terms after the transformation and adding the penalty terms so that the value becomes equivalent to the values of the evaluation function and constraint condition before the transformation. For example, the transforming unit 151 has the constraint selecting unit 152 and the auxiliary variable substituting unit 153. For example, the transforming unit 151 can realize the above by performing or repeating the transformation process by the constraint selecting unit 152 and the auxiliary variable substituting unit 153.

The constraint selecting unit 152 selects one auxiliary variable constraint from the list of auxiliary variable constraints shown by the auxiliary variable constraint information 141. For example, the constraint selecting unit 152 selects, from the list of auxiliary variable constraints shown by the auxiliary variable constraint information 141, one auxiliary variable constraint in which the auxiliary variable is not the configuration variable of another auxiliary variable constraint. In addition, in a case where there are a plurality of auxiliary variable constraints as described above, the constraint selecting unit 152 may select the auxiliary variable constraint on any basis from among a plurality of auxiliary variable constraints satisfying the condition.

The auxiliary variable substituting unit 153 performs a transformation process of transforming an evaluation function into a higher-order form based on the auxiliary variable constraint selected by the constraint selecting unit 152. For example, the auxiliary variable substituting unit 153 transforms an evaluation function into a higher-order form by substituting an auxiliary variable in an auxiliary variable constraint in the evaluation function shown by the evaluation function information 143 with a configuration variable with reference to the auxiliary variable constraint selected by the constraint selecting unit 152 and a coefficient of a penalty term corresponding to the selected auxiliary variable constraint included in the penalty term coefficient information 142. At this time, the auxiliary variable substituting unit 153 performs the transformation process so that, in a case where all the auxiliary variable constraints stored as the auxiliary variable constraint information 141 are satisfied, the value of the evaluation function before the transformation matches the value of the evaluation function after the transformation and, in a case where even one of the auxiliary variable constraints is not satisfied, the value of the evaluation function before the transformation is not become smaller than the value of the evaluation function after the transformation. By performing such a transformation process having a condition associated with the transformation, the auxiliary variable substituting unit 153 can transform the evaluation function to a higher order by adding an auxiliary variable to the high-order evaluation function after the transformation and lowering the order so that it can match the original evaluation function and the list of auxiliary variable constraints. That is to say, the auxiliary variable substituting unit 153 can transform a transformation target evaluation function into a higher-order evaluation function without an auxiliary variable while maintaining equivalence.

To be specific, for example, the auxiliary variable substituting unit 153 deletes, excluding a configuration variable of the selected auxiliary variable constraint, a term derived from the corresponding penalty term. For example, assume the evaluation function H=x₁x₂−2x₁y−2x₂y+3y+yx₃−2yz−2x₃z+3z+zx₄, the selected auxiliary variable constraint is z=yx₃, and a penalty term corresponding to the selected auxiliary variable constraint is Hz′=x₃y−2(x₃+y)z+3z. In this case, the auxiliary variable substituting unit 153 deletes, from the evaluation function, terms yz, x₃z and z derived from the penalty term excluding the configuration variable yx₃ of the selected auxiliary variable constraint. This transformation process results in the evaluation function H=x₁x₂−2x₁y−2x₂y+3y+yx₃+zx₄.

In addition, in a case where an evaluation function is given as a matrix Q, the deletion process as described above is equivalent to an operation of setting matrix elements representing the coefficients of the terms to 0. Note that z is a first-order monomial. For example, the variable may take 0 or 1. In such a case, the term z² can be equated to the first order term of z. That is to say, deleting z is equivalent to deleting z².

Further, the auxiliary variable substituting unit 153 subtracts 1, which is the coefficient a of the penalty term, in the term of a configuration variable of the selected auxiliary variable constraint of the evaluation function. The result is the evaluation function H=x₁x₂−2x₁y−2x₂y+3y+ (1−1)yx₃+zx₄, and the evaluation function H=x₁x₂−2x₁y−2x₂y+3y+zx₄.

In a case where the coefficient of the evaluation function is given as a matrix, the process of subtracting a value corresponding to the coefficient a described above is equivalent to an operation of subtracting the coefficient a from the matrix element showing the coefficient of the term (xy) of the configuration variable.

Further, the auxiliary variable substituting unit 153 substitutes the auxiliary variable z of the selected auxiliary variable constraint with the configuration variable yx₃ in the evaluation function. Consequently, a term including an auxiliary variable is rewritten into a higher-order term. For example, in the case of the example described in this example embodiment, the evaluation function H=x₁x₂−2x₁y−2x₂y+3y+yx₃x₄ holds. That is to say, it is possible to transform an evaluation function of quadratic form into a tertiary form.

For example, as described above, the auxiliary variable substituting unit 153 performs a transformation process such as deletion of a term derived from a penalty term other than a configuration variable in an evaluation function, subtraction of a value corresponding to a coefficient of a penalty term in a term of a configuration variable in an evaluation function, and substitution of a term of an auxiliary variable in an evaluation function, thereby transforming an evaluation function into higher-order form, such as transforming an evaluation function of quadratic form into a tertiary form while maintaining equivalence. In other words, with the respective processes described above, the auxiliary variable substituting unit 153 transforms a transformation target evaluation function into a higher order by adding an auxiliary variable constraint to an evaluation function after the transformation and adding a penalty term so that it is equivalent to an transformation original evaluation function.

Further, the auxiliary variable substituting unit 153 can instruct the constraint selecting unit 152 to select an unselected auxiliary variable constraint after the transformation process as described above. At this time, the auxiliary variable substituting unit 153 may be configured to delete an already selected auxiliary variable constraint from a selection target list of the auxiliary variable constraint information 141. In accordance with this, the selection of an auxiliary variable constraint by the constraint selecting unit 152 is performed, and the same transformation process by the auxiliary variable substituting unit 153 can be repeated. For example, assume the constraint selecting unit 152 selects an auxiliary variable constraint y=x₁x₂. In accordance with this, the auxiliary variable substituting unit 153 deletes terms yx₁, yx₂ and y derived from penalty terms from the evaluation function, and subtracts 1 corresponding to the coefficient a from the coefficient of the term x₁x₂. Moreover, the auxiliary variable substituting unit 153 substitutes y in the evaluation function with x₁x₂. As a result, the evaluation function H=x₁x₂x₃x₄ holds, and the evaluation function of quadratic form is transformed into an evaluation function of biquadratic form.

In addition, the transformation process by the constraint selecting unit 152 and the auxiliary variable substituting unit 153 may be configured to be repeated until the constraint selecting unit 152 selects all the auxiliary variable constraints included in the auxiliary variable constraint information 141, and the transformation process may be configured to be terminated at a time when some termination condition is satisfied, such as when the order is raised to a desired order. For example, the determination of whether or not the termination condition is satisfied may be configured to be performed by either the constraint selecting unit 152 or the auxiliary variable substituting unit 153.

Further, the auxiliary variable substituting unit 153 can store an evaluation function after the transformation such as the evaluation function H=x₁x₂−−2x₁y−−2x₂y+3y+yx₃x₄ and the evaluation function H=x₁x₂x₃x₄ as the evaluation function information 143 into the storing unit 140. The auxiliary variable substituting unit 153 may be configured to store the evaluation functions after the transformation as the evaluation function information 143 into the storing unit 140 after the termination condition described above is satisfied.

The output unit 154 outputs the evaluation functions after the transformation included in the evaluation function information 143, and so forth. For example, the output unit 154 can display the evaluation functions after the transformation and so forth on the screen display unit 120, or transmit to an external device such as an external optimization apparatus via the communication I/F unit 130. The output unit 154 may output any information other than those illustrated above.

The above is an example configuration of the transformation apparatus 100. Subsequently, an example of operation of the transformation apparatus 100 will be described with reference to FIG. 5.

FIG. 5 is a flowchart showing an example of operation of the transformation apparatus 100. Referring to FIG. 5, the constraint selecting unit 152 selects one auxiliary variable constraint from the list of auxiliary variable constraints shown by the auxiliary variable constraint information 141 (step S101). For example, the constraint selecting unit 152 selects, from the list of auxiliary variable constraints shown by the auxiliary variable constraint information 141, one auxiliary variable constraint in which an auxiliary variable is not a configuration variable of another auxiliary variable constraint.

The auxiliary variable substituting unit 153 substitutes an auxiliary variable in the auxiliary variable constraint in the evaluation function shown by the evaluation function information 143 with a configuration variable with reference to the auxiliary variable constraint selected by the constraint selecting unit 152 and a coefficient of a penalty term corresponding to the selected auxiliary variable constraint included in the penalty term coefficient information 142. For example, the auxiliary variable substituting unit 153 deletes a term derived from the corresponding penalty term excluding a configuration variable of the selected auxiliary variable constraint (step S102). Moreover, the auxiliary variable substituting unit 153 subtracts a coefficient a in the penalty term from a term of the configuration variable of the selected auxiliary variable constraint of the evaluation function (step S103). Moreover, the auxiliary variable substituting unit 153 substitutes the auxiliary variable of the selected auxiliary variable constraint with the configuration variable in the evaluation function (step S104).

The auxiliary variable substituting unit 153 can instruct the constraint selecting unit 152 to select an unselected auxiliary variable constraint after the transformation process as described above. At this time, the auxiliary variable substituting unit 153 may be configured to delete an already selected auxiliary variable constraint from a selection target list of the auxiliary variable constraint information 141 (step S105).

In a case where the auxiliary variable constraint information 141 includes unselected auxiliary variable constraints (step S106, Yes), the constraint selecting unit 152 selects an auxiliary variable constraint from among the unselected auxiliary variable constraints (step S101). On the other hand, in a case where the auxiliary variable constraint information 141 does not include an unselected auxiliary variable constraint (step S106, No), the output unit 154 can output the evaluation function after the transformation and so forth (step S107).

The above is an example of operation of the transformation apparatus 100.

Thus, the transformation apparatus 100 includes the constraint selecting unit 152 and the auxiliary variable substituting unit 153. According to such a configuration, the auxiliary variable substituting unit 153 can perform a transformation process of transforming an evaluation function into a higher-order form based on an auxiliary variable constraint selected by the constraint selecting unit 152. As a result, it is possible to handle an input of higher-order form as it is. Moreover, according to the transformation apparatus 100 described in this example embodiment, for example, an evaluation function and a list of auxiliary variable constraints handled in QUBO and the like can be used as they are to perform transformation into a higher-order evaluation function.

In addition, the configuration of the transformation apparatus 100 is not limited to the case illustrated in this example embodiment. For example, FIG. 6 shows another example configuration of the transformation apparatus 100. Referring to FIG. 6, the arithmetic processing unit 150 of the transformation apparatus 100 may have a directed graph creating unit 155 in addition to the configuration illustrated in FIG. 1 by loading and executing the program 144.

The directed graph creating unit 155 creates a directed graph structure showing a parent-child relation between auxiliary variable constraints for a list of auxiliary variable constraints stored in the auxiliary variable constraint information 141. For example, the directed graph creating unit 155 creates a directed graph structure having a tree structure. Consequently, the constraint selecting unit 152 selects one constraint from a list of auxiliary variable constraints that has directed graph structure, for example, selects in order from an auxiliary variable constraint corresponding to the root of the tree structure. The constraint selecting unit 152 selects one constraint from the list of auxiliary variable constraints with directed graph structure, so that the constraint selection can be made more efficient.

For example, the directed graph creating unit 155 creates a directed graph structure by selecting in order auxiliary variable constraints from the list of auxiliary variable constraints, adding auxiliary variable constraints to be parent to a parent list, and adding auxiliary variable constraints to be child to a child list. In other words, in a case where an auxiliary variable of a certain auxiliary variable constraint appears as a configuration variable of another auxiliary variable constraint, the directed graph creating unit 155 creates a directed graph structure in which a directed side is made to correspond to the above relation. For example, in a case where an auxiliary variable of one auxiliary variable constraint L₁ is a configuration variable of another auxiliary variable constraint L₂, the directed graph creating unit 155 determines the auxiliary variable constraint L₁ as a child of the auxiliary variable constraint L₂. Alternatively, in a case where an auxiliary variable of one auxiliary variable constraint L₁ is a configuration variable of another auxiliary variable constraint L₂, the directed graph creating unit 155 determines the auxiliary variable constraint L₂ as the parent of the auxiliary variable constraint L₁. For example, the directed graph creating unit 155 checks the parent-child relations for all the auxiliary variable constraints included in the list of auxiliary variable constraints, and creates a directed graph structure so that the child is located below the parent.

FIG. 7 shows an example of a directed graph structure created by the directed graph creating unit 155 in a case where y=x₁x₂ and z=yx₃ are included in the list of auxiliary variable constraints. For example, in the case illustrated in FIG. 7, the auxiliary variable y of the auxiliary variable constraint y=x₁x₂ is a configuration variable of the other auxiliary variable constraint z=yx₃. Therefore, the directed graph creating unit 155 determines the auxiliary variable constraint y=x₁x₂ as a child of the auxiliary variable constraint z=yx₃, and creates a directed graph structure as illustrated in FIG. 7. According to the directed graph structure as illustrated in FIG. 7, for example, the constraint selecting unit 152 can select auxiliary variable constraints in order from above.

In addition, the directed graph creating unit 155 may create a set Lᵣₒₒₜ of auxiliary variable constraints in which parent is empty and instruct the constraint selecting unit 152 to select an auxiliary variable constraint from the set Lᵣₒₒₜ. Moreover, the directed graph creating unit 155 may be configured to, in deleting an auxiliary variable constraint from the set Lᵣₒₒₜ in accordance with the transformation process by the auxiliary variable substituting unit 153, add an auxiliary variable constraint to the set Lᵣₒₒₜ in which an auxiliary variable constraint to be parent is empty.

Thus, by configuring in a manner that the constraint selecting unit 152 selects an auxiliary variable constraint based on a directed graph structure created by the directed graph creating constraint selecting unit 155, the order of selection of auxiliary variable constraints can be determined, and the constraint selection can be made more efficient.

### Second Example Embodiment

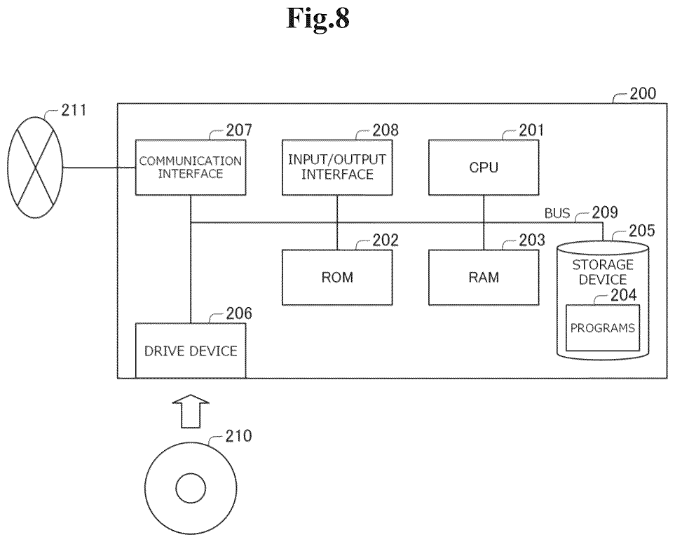

In a second example embodiment of the present disclosure, a transformation apparatus 200, which is an information processing apparatus that transforms an evaluation function into a higher-order evaluation function than the evaluation function, will be described. FIG. 8 shows an example of the hardware configuration of the transformation apparatus 200. Referring to FIG. 8, the transformation apparatus 200 has, as an example, the following hardware configuration including:
a CPU (Central Processing Unit) 201 (arithmetic logic unit);
a ROM (Read Only Memory) 202 (memory unit);
a RAM (Random Access Memory) 203 (memory unit);
programs 204 loaded into the RAM 203;
a storage device 205 that stores the programs 204;
a drive device 206 that reads from and writes into a recording medium 210 external to the information processing apparatus;
a communication interface 207 that connects with a communication network 211 external to the information processing apparatus;
an input/output interface 208 that inputs and outputs data; and
a bus 209 that connects the components

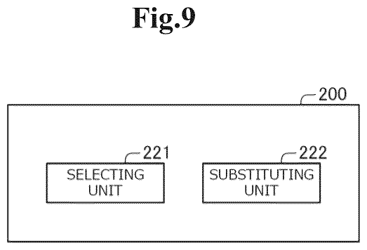

Further, the transformation apparatus 200 can realize functions as a selecting unit 221 and a substituting unit 222 shown in FIG. 9 by acquisition and execution of the programs 204 by the CPU 201. The programs 204 are, for example, stored in advance in the storage device 205 or the ROM 202, and are loaded into the RAM 203 or the like and executed by the CPU 201 as necessary. Moreover, the programs 204 may be provided to the CPU 201 via the communication network 211, or the programs may be stored in advance in the recording medium 210 and read out by the drive device 206 and provided to the CPU 201.

FIG. 8 shows an example of the hardware configuration of the transformation apparatus 200. The hardware configuration of the transformation apparatus 200 is not limited to the abovementioned case. For example, the transformation apparatus 200 may be configured with part of the abovementioned configuration, such as not having the drive device 206.

The selecting unit 221 selects an auxiliary variable constraint from a list of auxiliary variable constraints in which the product of certain variables matches another variable.

The substituting unit 222 performs a substitution process based on the auxiliary variable constraint selected by the selecting unit 221, and thereby transforms a transformation target evaluation function represented by a polynomial with a plurality of variables into a higher-order evaluation function than the evaluation function.

Thus, the transformation apparatus 200 includes the selecting unit 221 and the substituting unit 222. According to such a configuration, the substituting unit 222 performs the substitution process based on the auxiliary variable constraint selected by the selecting unit 221, and thereby transforms a transformation target evaluation function represented by a polynomial with a plurality of variables into a higher-order evaluation function than the evaluation function. As a result, the optimization of a higher order form can be performed efficiently.

The transformation apparatus 200 described above can be realized by incorporating a predetermined program into an information processing apparatus such as the transformation apparatus 200. To be specific, a program as another aspect of the present invention is a program for causing an information processing apparatus such as the transformation apparatus 200 to realize processes to select an auxiliary variable constraint from a list of auxiliary variable constraints in which the product of certain variables matches another variable, and perform a substitution process based on the selected auxiliary variable constraint and thereby transform a transformation target evaluation function represented by a polynomial with a plurality of variables into a higher-order evaluation function than the evaluation function.

Further, a transformation method performed by an information processing apparatus such as the transformation apparatus 200 described above is a method in which the information processing apparatus such as the transformation apparatus 200 selects an auxiliary variable constraint from a list of auxiliary variable constraints in which the product of certain variables matches another variable, and performs a substitution process based on the selected auxiliary variable constraint and thereby transforms a transformation target evaluation function represented by a polynomial with a plurality of variables into a higher-order evaluation function than the evaluation function.

Even if the invention of a program, or a computer-readable recording medium with a program recorded, or a transformation method has the above configuration, the purpose of the present invention described above can be achieved because the same action and effect as the transformation apparatus 200 described above are achieved.

### <Supplementary Notes>

The whole or part of the example embodiments disclosed above can be described as the following supplementary notes. Hereinafter, the overview of the transformation apparatus and so forth in the present invention will be described. However, the present invention is not limited to the following configurations.

### (Supplementary Note 1)

A transformation apparatus comprising:
a selecting unit that selects an auxiliary variable constraint from a list of auxiliary variable constraints represented in a form in which a product of variables matches another variable; and
a substituting unit that performs a substitution process based on the auxiliary variable constraint selected by the selecting unit and thereby transforms an evaluation function to be transformed represented by a polynomial with a plurality of variables into a higher-order evaluation function than the evaluation function.

### (Supplementary Note 2)

The transformation apparatus according to supplementary note 1, wherein:
the auxiliary variable constraint is represented in a form in which a configuration variable that is a product of variables matches an auxiliary variable that is a variable; and
the selecting unit selects the auxiliary variable constraint from among auxiliary variable constraints in which an auxiliary variable is not a configuration variable of another auxiliary variable constraint in the list of auxiliary variable constraints.

### (Supplementary Note 3)

The transformation apparatus according to supplementary note 1, comprising
a creating unit that creates a directed graph structure showing a parent-child relation between auxiliary variable constraints based on the list of auxiliary variable constraints, wherein the selecting unit selects the auxiliary variable constraint based on the directed graph structure created by the creating unit.

### (Supplementary Note 4)

The transformation apparatus according to supplementary note 3, wherein:
the auxiliary variable constraint is represented in a form in which a configuration variable that is a product of variables matches an auxiliary variable that is a variable; and
in a case where an auxiliary variable of an auxiliary variable constraint is a configuration variable of another auxiliary variable constraint, the creating unit determines the auxiliary variable constraint as a child of the other auxiliary variable constraint, and creates the directed graph structure showing the parent-child relation corresponding to a result of the determination.

### (Supplementary Note 5)

The transformation apparatus according to supplementary note 4, wherein in a case where an auxiliary variable of an auxiliary variable constraint appears as a configuration variable of another auxiliary variable constraint, the creating unit creates the directed graph structure in which a directed side is made to correspond to a relation in which the auxiliary variable of the auxiliary variable constraint appears as the configuration variable of the other auxiliary variable constraint.

### (Supplementary Note 6)

The transformation apparatus according to supplementary note 1, wherein:
a coefficient of a penalty term corresponding to an auxiliary variable constraint is stored at least in advance; and
the substituting unit performs a subtraction or deletion process on a term derived from a penalty term corresponding to the auxiliary variable constraint selected by the selecting unit in the evaluation function to be transformed.

### (Supplementary Note 7)

The transformation apparatus according to supplementary note 1, wherein
the substituting unit transforms the evaluation function to be transformed into the higher-order evaluation function than the evaluation function so that, in a case where all the auxiliary variable constraints included in the list of auxiliary variable constraints are satisfied, a value of the evaluation function to be transformed and a value of the evaluation function after the transformation match and, in a case where all the auxiliary variable constraints included in the list of auxiliary variable constraints are not satisfied, the value of the evaluation function to be transformed is not smaller than the value of the evaluation function after the transformation.

### (Supplementary Note 8)

The transformation apparatus according to supplementary note 1, wherein
the substituting unit adds an auxiliary variable constraint to the evaluation function after the transformation and adds penalty terms, and thereby transforms the evaluation function to be transformed into the higher-order evaluation function than the evaluation function so as to be equivalent to the evaluation function before the transformation including a constraint condition.

### (Supplementary Note 9)

A transformation method by an information processing apparatus, the transformation method comprising:
selecting an auxiliary variable constraint from a list of auxiliary variable constraints represented in a form in which a product of variables matches another variable; and
performing a substitution process based on the selected auxiliary variable constraint and thereby transforming an evaluation function to be transformed represented by a polynomial with a plurality of variables into a higher-order evaluation function than the evaluation function.

### (Supplementary Note 10)

A non-transitory computer-readable recording medium with a program recorded thereon, the program comprising instructions for causing an information processing apparatus to execute processes to:
select an auxiliary variable constraint from a list of auxiliary variable constraints represented in a form in which a product of variables matches another variable; and
perform a substitution process based on the selected auxiliary variable constraint and thereby transform an evaluation function to be transformed represented by a polynomial with a plurality of variables into a higher-order evaluation function than the evaluation function.

Although the present invention has been described above with reference to the above example embodiments, the present invention is not limited to the example embodiments described above. The configuration and details of the present invention can be changed in various manners that can be understood by those skilled in the art within the scope of the present invention.

### REFERENCE SIGNS LIST

100 transformation apparatus
110 operation input unit
120 screen display unit
130 communication I/F unit
140 storing unit
141 auxiliary variable constraint information
142 penalty term coefficient information
143 evaluation function information
144 program
150 arithmetic processing unit
151 transforming unit
152 constraint selecting unit
153 auxiliary variable substituting unit
154 output unit
155 directed graph creating unit
200 transformation apparatus
201 CPU
202 ROM
203 RAM
204 programs
205 storage device
206 drive device
207 communication interface
208 input/output interface
209 bus
210 recording medium
211 communication network
221 selecting unit
222 substituting unit

What is claimed is:

1. A transformation apparatus comprising:
at least one memory storing processing instructions; and
at least one processor configured to execute the processing instructions to:
an auxiliary variable constraint from a list of auxiliary variable constraints represented in a form in which a product of variables matches another variable; and
a substitution process based on the selected auxiliary variable constraint and thereby transform an evaluation function to be transformed represented by a polynomial with a plurality of variables into a higher-order evaluation function than the evaluation function.

2. The transformation apparatus according to claim 1, wherein:
the auxiliary variable constraint is represented in a form in which a configuration variable that is a product of variables matches an auxiliary variable that is a variable; and
the at least one processor is configured to execute the processing instructions to select the auxiliary variable constraint from among auxiliary variable constraints in which an auxiliary variable is not a configuration variable of another auxiliary variable constraint in the list of auxiliary variable constraints.

3. The transformation apparatus according to claim 1, wherein the at least one processor is configured to execute the processing instructions to:
create a directed graph structure showing a parent-child relation between auxiliary variable constraints based on the list of auxiliary variable constraints; and
select the auxiliary variable constraint based on the created directed graph structure.

4. The transformation apparatus according to claim 3, wherein:
the auxiliary variable constraint is represented in a form in which a configuration variable that is a product of variables matches an auxiliary variable that is a variable; and
the at least one processor is configured to execute the processing instructions to:
in a case where an auxiliary variable of an auxiliary variable constraint is a configuration variable of another auxiliary variable constraint, determine the auxiliary variable constraint as a child of the other auxiliary variable constraint, and create the directed graph structure showing the parent-child relation corresponding to a result of the determination.

5. The transformation apparatus according to claim 4, wherein the at least one processor is configured to execute the processing instructions to
in a case where an auxiliary variable of an auxiliary variable constraint appears as a configuration variable of another auxiliary variable constraint, create the directed graph structure in which a directed side is made to correspond to a relation in which the auxiliary variable of the auxiliary variable constraint appears as the configuration variable of the other auxiliary variable constraint.

6. The transformation apparatus according to claim 1, wherein:
a coefficient of a penalty term corresponding to an auxiliary variable constraint is stored at least in advance; and
the at least one processor is configured to execute the processing instructions to: perform a subtraction or deletion process on a term derived from a penalty term corresponding to the selected auxiliary variable constraint in the evaluation function to be transformed.

7. The transformation apparatus according to claim 1, wherein the at least one processor is configured to execute the processing instructions to
transform the evaluation function to be transformed into the higher-order evaluation function than the evaluation function so that, in a case where all the auxiliary variable constraints included in the list of auxiliary variable constraints are satisfied, a value of the evaluation function to be transformed and a value of the evaluation function after the transformation match and, in a case where all the auxiliary variable constraints included in the list of auxiliary variable constraints are not satisfied, the value of the evaluation function to be transformed is not smaller than the value of the evaluation function after the transformation.

8. The transformation apparatus according to claim 1, wherein the at least one processor is configured to execute the processing instructions to
add an auxiliary variable constraint to the evaluation function after the transformation and add penalty terms, and thereby transform the evaluation function to be transformed into the higher-order evaluation function than the evaluation function so as to be equivalent to the evaluation function before the transformation including a constraint condition.

9. A transformation method by an information processing apparatus, the transformation method comprising:
selecting an auxiliary variable constraint from a list of auxiliary variable constraints represented in a form in which a product of variables matches another variable; and
performing a substitution process based on the selected auxiliary variable constraint and thereby transforming an evaluation function to be transformed represented by a polynomial with a plurality of variables into a higher-order evaluation function than the evaluation function.

10. A non-transitory computer-readable recording medium with a program recorded thereon, the program comprising instructions for causing an information processing apparatus to execute processes to:
select an auxiliary variable constraint from a list of auxiliary variable constraints represented in a form in which a product of variables matches another variable; and
perform a substitution process based on the selected auxiliary variable constraint and thereby transform an evaluation function to be transformed represented by a polynomial with a plurality of variables into a higher-order evaluation function than the evaluation function.
